(19) United States
(12) Patent Application Publication
(10) Pub. No.: US 2010/0014711 A1
(43) Pub. Date: Jan. 21, 2010

(54) Method for controlling an illumination in a vehicle interior in dependence on a head pose detected with a 3D sensor

(75) Inventors: Jaime Camhi, Pacifica, CA (US); Daniel Rosario, Santa Cruz, CA (US); Lorenz Laubinger, San Francisco, CA (US); Arne Stoschek, Palo Alto, CA (US)

Correspondence Address: MANFRED BECK PA, PO BOX 431255, SOUTH MIAMI, FL, 33243-1255, US

(73) Assignee: VOLKSWAGEN GROUP OF AMERICA, INC., Auburn Hills, MI (US)

(21) Appl. No.: 12/173,907

(22) Filed: Jul. 16, 2008

(51) Int. Cl. G06K 9/78

(52) U.S. Cl. 382/104

(57) ABSTRACT

A method for controlling an illumination in a vehicle interior includes the steps of collecting, with a 3D sensor, three-dimensional information about a driver and detecting the driver as an object in a three-dimensional space by processing the three-dimensional information about the driver. At least one three-dimensional driver characteristic, such as a head pose, a head position, a body position and a body posture, is determined. An area of attention of the driver is determined by evaluating the at least one three-dimensional driver characteristic. An illumination scheme for the vehicle interior is determined based on the area of attention of the driver such that vision conditions for the driver are improved. A method for detecting driver drowsiness and a method for controlling a visibility of display screen information in the vehicle interior are also provided.

### BACKGROUND OF THE INVENTION

### Field of the Invention

The invention relates to a method for controlling an illumination in a vehicle interior in dependence on a head pose detected with a 3D (three-dimensional) sensor. The invention further relates to a method for detecting driver drowsiness, and to a method for controlling a visibility of display screen information.

Conventional vehicle interior lighting is mainly used for general illumination while entering or exiting the vehicle. Another function of conventional vehicle interior lighting is to provide a reading light for vehicle occupants. In modern vehicles, interior lighting has also a stylistic purpose, in addition to the purely functional illumination purposes. For example, the interior lighting has a direct effect on the driver's perceived quality of the vehicle. In certain cases, the interior lighting of a vehicle also influences the driver's attention. Displays and control elements in the vehicle's center stack, center console and instrument cluster have a strong effect on interior lighting because these displays and control elements need high illumination levels in order to function properly. Good illumination of these elements is important when the user interacts with them. On the other hand, an illumination may be undesirable when the user has to concentrate on the road.

Additionally, equipment such as a display for a navigation system has a constantly changing imagery that may generate distractions because of light changes and movement on the display. Also, displays and control elements in the center stack, the center console and on the instrument cluster may create reflections on the windshield and the side windows of the vehicle, which may be distracting or tiring during night driving. Further, displays on the center stack, center console, instrument cluster, and dashboard may cause glare under certain illumination or light conditions.

Further problems arise from the simple fact that modern vehicles have a large number of buttons, dials, turn knobs, sliders, displays, touch screens and other control elements in a vehicle. Since all of these elements convey information, a driver may be overloaded with information and may become distracted. The distraction may be increased when the control elements, displays or screens are illuminated.

The above-described problems have been addressed partially by having two different illumination schemes for displays. One illumination scheme is provided for night driving and another, brighter illumination scheme is provided for day driving. The illumination scheme for day driving is the default setting. The illumination scheme for night driving is activated when the user turns on the vehicle's headlights. Aside from using such illumination schemes for the instrument cluster, the center stack and the center console, this solution has generally been limited to the use of soft illumination for these areas. Some vehicles also have a knob for dimming the interior lights on the instrument cluster or a button for turning the central navigation display off altogether.

In order to reduce potential driver distraction, German Patent Application Publication No. DE 10 2005 023 697 A1 provides a system with a video camera disposed in a motor vehicle for detecting the line of vision, positions and movements of a motor vehicle passenger. The video camera is equipped with an image processing device. A controller produces control signals for lighting units in the motor vehicle, using an output of the video camera. For example, if a passenger looks for an item in a given region in the vehicle, the system can control the lighting units to provide limited illumination in the given region of the vehicle for a short period of time.

In a similar manner, German Utility Model No. DE 298 22 554 U1 describes a lighting system for illuminating areas in the interior of a vehicle. A sensor unit detects movement in the vehicle interior and, based on an evaluation of the movement, an area is illuminated. For example, if a driver inserts the vehicle key into the ignition lock, the area around the ignition lock can be illuminated.

Japanese Patent Application Publication No. JP 2006 021591 A discloses an illumination control system to control the brightness level of an illumination of an intra-cabin apparatus. A line-of-view sensing device monitors the line of view of the driver or passenger in the front seat. An optical sensor measures a brightness outside the car. When it is darker than a specified brightness level outside the car, the illuminations of the intra-cabin apparatuses are generally reduced to a brightness level which is darker than the normal brightness level so that the driver or passenger in the front seat is not bothered by the illumination of the intra-cabin apparatus and only that apparatus, which is in the line-of-view of the driver, is turned from the reduced brightness level to the normal brightness level, so that the driver can see the apparatus clearly.

Further, German Patent No. DE 103 39 314 B3 discloses a method for controlling a dual-view display in a vehicle, wherein the dual-view display can provide driver-related information for a driver and can at the same time provide different information for a passenger. The current line of vision of the driver is continually detected and the driver-related information is displayed when the driver makes visual contact with the dual-view display, whereas different information that is not driver-related may be displayed during the intervals without visual contact. The current line of vision is determined by a video-based detection of the head rotation and/or eye movement of the driver, based on a static or dynamic detection method. Since the driver can in this way be prevented from seeing information that is not driver-related, the potential for distraction caused by the dual-view display is reduced.

In addition to the problem of driver distraction, there is also the problem of drivers becoming drowsy and failing asleep while driving. A number of patents such as U.S. Pat. No. 6,304,187 or U.S. Pat. No. 6,717,518 describe methods for preventing a driver from failing asleep by detecting drowsiness based on the driver's eyes blinking and by providing an acoustic or optical alarm.

### SUMMARY OF THE INVENTION

It is accordingly an object of the invention to increase driver safety through the use of an improved control of illumination in a vehicle interior. It is in particular an object of the invention to provide a method for controlling a vehicle interior illumination which increases driver safety by reducing driver distraction and driver fatigue. Another object of the invention is to provide a method for detecting driver drowsiness in order to increase driver safety. A further object of the invention is to provide a method for controlling a visibility of display screen information such that driver safety is increased.

With the foregoing and other objects in view there is provided, in accordance with the invention, a method for controlling an illumination in a vehicle interior, wherein the method includes the steps of:

collecting, with a 3D sensor provided in a vehicle interior, three-dimensional information about a driver in the vehicle interior;

detecting the driver as an object in a three-dimensional space by processing the three-dimensional information about the driver;

determining at least one three-dimensional driver characteristic selected from the group of a head pose, a head position, a body position and a body posture;

determining an area of attention of the driver by evaluating the at least one three-dimensional driver characteristic; and

determining an illumination scheme based on the area of attention of the driver such that vision conditions for the driver are improved.

An advantage of using a 3D sensor, as opposed to using a conventional 2D video camera, is that a head pose, a head position, a body position and a body posture can be detected more reliably. Conventional 2D cameras detect only a luminosity image of an object and thus provide only a projection image of a three-dimensional object. Any spatial information needs to be calculated from two-dimensional images. In contrast, appropriate 3D sensors such as photonic mixer devices (PMDs) detect a luminosity image and also detect depth information of the object.

Another mode of the invention includes determining a peripheral view region of the driver based on the at least one three-dimensional driver characteristic; and determining an illumination scheme having a reduced brightness for light sources in the peripheral view region of the driver. This advantageously increases safety by reducing distractions caused by bright light in the driver's peripheral view.

Another mode of the invention includes improving vision conditions during night driving by reducing an illumination for displays in the vehicle interior, if the step of determining an area of attention of the driver determines that the driver looks straight ahead. When the driver looks straight ahead, i.e. when the driver looks at the road, it is advantageous to reduce the illumination of displays in the vehicle during night driving in order to reduce distraction caused by light in the vehicle interior.

Another mode of the invention includes sensing an ambient light level by using a photosensor; determining an illumination scheme based on the area of attention of the driver and based on the ambient light level such that a back illumination of a display is locally adjusted for different regions of the display in order to enhance an overall display contrast. An advantage of locally adjusting the back illumination of different regions of a display is that an illumination can be adjusted so that glare is reduced and overall contrast is increased. The photosensor is preferably integrated in the display.

Another mode of the invention includes using, as the 3D sensor, a sensor device such as a time-of-flight 3D camera, a stereoscopic camera system, a laser scanner system and a capacitive proximity sensor.

Another mode of the invention includes providing the 3D sensor on a vehicle component such as a vehicle A-pillar, a vehicle roof liner and a vehicle rear view mirror. These mounting locations for the 3D sensor are advantageous because they are forward of the driver's head and allow the 3D sensor to reliably scan the driver's head.

Another mode of the invention includes adjusting an illumination for a device such as a display, a push button, a rotary dial, a rotary-push knob, a scroll wheel and an instrument cluster in accordance with the illumination scheme. An advantage of adjusting the illumination for all kinds of control elements and displays is that distraction caused by light is reduced. Also, an adjustable illumination increases the perceived quality of the vehicle's interior.

Another mode of the invention includes adjusting an ambient lighting source such as a dome light and/or a foot well lighting source in accordance with the illumination scheme. Adjusting an ambient lighting source may be helpful during night driving if the driver searches for something that he or she placed on the front passenger seat or in the footwell. In this case it may be advantageous to evaluate a body position or body posture of the driver in order to determine whether the driver leans over to the passenger side in order to grab an item placed on the passenger seat.

Another mode of the invention includes increasing an illumination level for a display located in the area of attention of the driver in order to increase the legibility of the display.

With the objects of the invention in view there is also provided, a method for detecting driver drowsiness, wherein the method includes the steps of:

collecting, with a 3D sensor provided in a vehicle interior, three-dimensional information about a driver in the vehicle interior;

detecting the driver as an object in a three-dimensional space by processing the three-dimensional information about the driver;

determining at least one three-dimensional driver characteristic selected from the group of a head pose, a head position, a body position and a body posture;

detecting a driver drowsiness based on an evaluation of the at least one three-dimensional driver characteristic; and

triggering a measure for alerting the driver, if a driver drowsiness is detected.

Another mode of the invention includes detecting eye blinking information by monitoring an eye of the driver; and detecting a driver drowsiness based on an evaluation of the at least one three-dimensional driver characteristic and the eye blinking information. The eye blinking information includes for example a duration of an eye closure and an eye blinking rate. By combining an evaluation of the at least one three-dimensional driver characteristic and the eye blinking information, it is possible to improve the reliability of the drowsiness detection.

An advantage of the above-defined method is that certain head poses and head movements that indicate drowsiness can be detected with a 3D sensor and an alarm can be triggered when there is a risk of the driver failing asleep. Another advantage of the above-defined method is that it does not solely rely on an evaluation of the driver's eyes opening and closing as is the case with many conventional methods that detect drowsiness. Some of the conventional methods that evaluate an eye blinking behavior may therefore provide unreliable results if the driver wears sunglasses.

Another mode of the invention includes increasing a lighting level in the vehicle interior for alerting the driver, if a driver drowsiness is detected.

With the objects of the invention in view there is also provided, a method for controlling a visibility of display screen information, wherein the method includes the steps of:

collecting, with a 3D sensor provided in a vehicle interior, three-dimensional information about a driver in the vehicle interior;

detecting the driver as an object in a three-dimensional space by processing the three-dimensional information about the driver;

determining at least one three-dimensional driver characteristic selected from the group of a head pose, a head position, a body position and a body posture;

evaluating the at least one three-dimensional driver characteristic; and

controlling a display screen such that a visibility of information on the display screen is adjusted in dependence on an evaluation of the at least one driver characteristic.

An advantage of controlling a display screen based on a head pose or a head position is that it is possible to reduce distraction caused by an illuminated display, in particular if the display information is not static but changes with time, such as a continuously updated navigation map. As mentioned above, by using a 3D sensor, as opposed to using a conventional 2D video camera, it is possible to detect a head pose, a head position, a body position and a body posture in a more reliable manner.

In accordance with another mode of the invention, the step of controlling the display screen includes selectively increasing a brightness of the display screen, if an evaluation of the at least one three-dimensional driver characteristic determines that the driver looks at the display screen and reducing a brightness of the display screen, if an evaluation of the at least one three-dimensional driver characteristic determines that the driver does not look at the display screen. The step of reducing brightness is understood as dimming the display or turning off the display. The display may advantageously be turned off after the driver does not look at the display for a given period of time.

Another mode of the invention includes providing, with the display screen, a first display screen information for the driver, the first display screen information being viewable in a first display viewing angle range and providing, with the display screen, a second display screen information for a passenger, the second display screen information being viewable in a second display viewing angle range; and controlling the display screen such that the second display screen information is turned off, if an evaluation of the at least one three-dimensional driver characteristic determines that the driver looks at the second display screen information. In case of a multi-view display, the display information that a user can see depends on the viewing angle. A multi-view display can therefore be used in a vehicle in order to present driver-relevant information to the driver and different information to a vehicle passenger.

For example, the display may present navigation information to the driver and, at the same time, an entertainment video to the passenger. If the driver tries to watch the entertainment video, the driver has to lean over to the passenger side in order to move his or her head into the display viewing angle range for the entertainment video. The head position and the head pose of the driver can be determined with the 3D sensor. If it is determined that the driver looks at the screen information intended for the passenger, the display information for the passenger is then turned off in order to prevent driver distraction.

Another mode of the invention includes providing, with the display screen, a first display screen information for the driver, the first display screen information being viewable in a first display viewing angle range and providing, with the display screen, a second display screen information for a passenger, the second display screen information being viewable in a second display viewing angle range; and controlling the display screen such that at least the first display viewing angle range selectively expands and contracts in dependence on an evaluation of the at least one three-dimensional driver characteristic. Viewing conditions can thus be optimized for the driver.

Another mode of the invention includes providing the display screen such that the display screen is angled toward a front passenger for presenting display screen information to the front passenger; and controlling the display screen such that the display screen information is turned off, if an evaluation of the at least one three-dimensional driver characteristic determines that the driver looks at the display screen information.

Other features which are considered as characteristic for the invention are set forth in the appended claims.

Although the invention is illustrated and described herein as embodied in a method for controlling an illumination in a vehicle interior, a method for detecting driver drowsiness, and a method for controlling a visibility of display screen information, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic perspective view of a vehicle interior including a 3D sensor in accordance with the invention;

FIG. 2 is a block diagram illustrating in a simplified manner an exemplary embodiment of an illumination control according to the invention;

FIG. 3 is a block diagram illustrating in a simplified manner an exemplary embodiment of a drowsiness detection according to the invention;

FIG. 4 is a block diagram illustrating in a simplified manner an exemplary embodiment of a display control according to the invention; and

FIG. 5 is a schematic top view for illustrating display viewing angle ranges of a multi-view display controlled in accordance with the invention.

### DESCRIPTION OF THE PREFERRED EMBODIMENTS

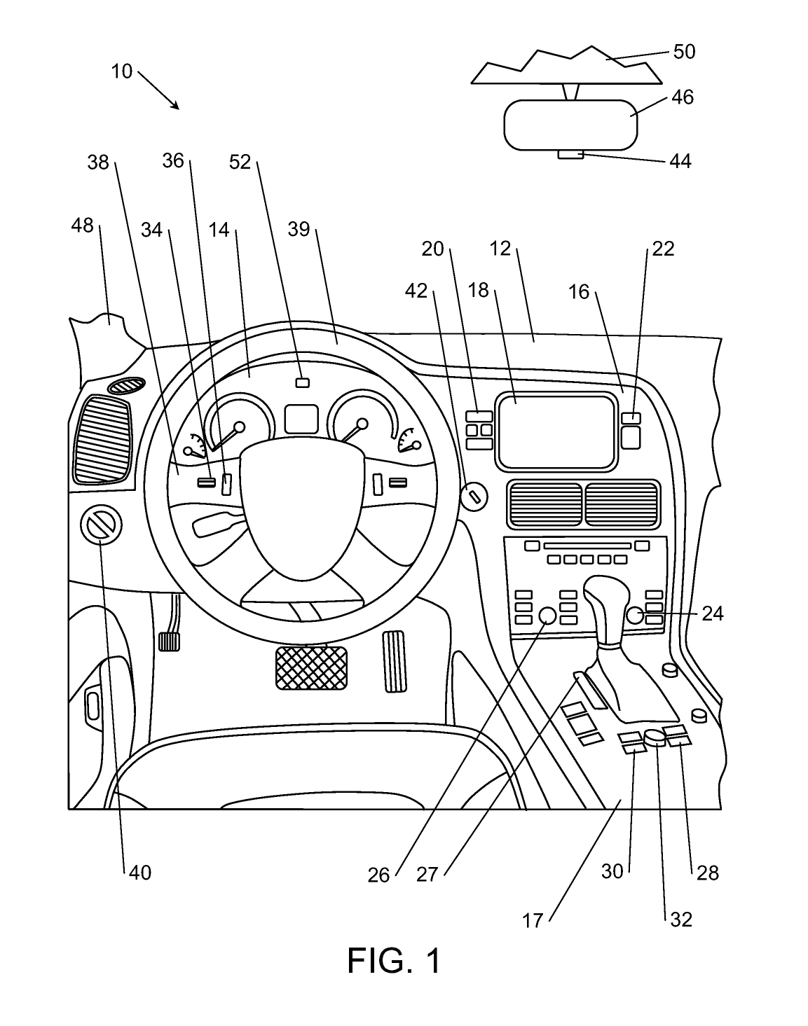

Referring now to the figures of the drawings in detail and first, particularly, to FIG. 1 thereof, there is shown a diagrammatic perspective view of a vehicle interior 10. The vehicle interior 10 includes a dashboard 12 with an instrument cluster 14, a center stack 16 and a center console 17. The center stack 16 includes a display screen 18 and a number of push buttons 20, 22, rotary dials 24, 26 and further control devices such as scroll wheels or touchpads for a climate control system, a multimedia system and a navigation system. The display screen 18 may be embodied as a touchscreen in order to provide input functions. The display screen 18 may also be embodied as a multi-view display screen.

The center console 17 includes a gear indicator display 27, a number of push buttons 28, 30 and a rotary-push knob 32. Further control devices provided in the vehicle interior 10 include for example a rotary light switch 40 and an ignition lock 42 on the dashboard 12 and push buttons 36 and scroll wheels 34 on the spokes 38 of the steering wheel 39.

In accordance with the invention, a 3D (three-dimensional) sensor 44 is integrated in the vehicle rear view mirror 46. Alternatively, the 3D sensor 44 may be integrated in the vehicle A-pillar 48 or the vehicle roof liner 50. A photosensor 52 for measuring an ambient light level is provided in the instrument cluster 14. The 3D sensor 44 may be embodied as a CMOS (complementary metal-oxide-semiconductor) chip that measures the distance between the chip and features of a three-dimensional object, in this case a driver 74, in real time.

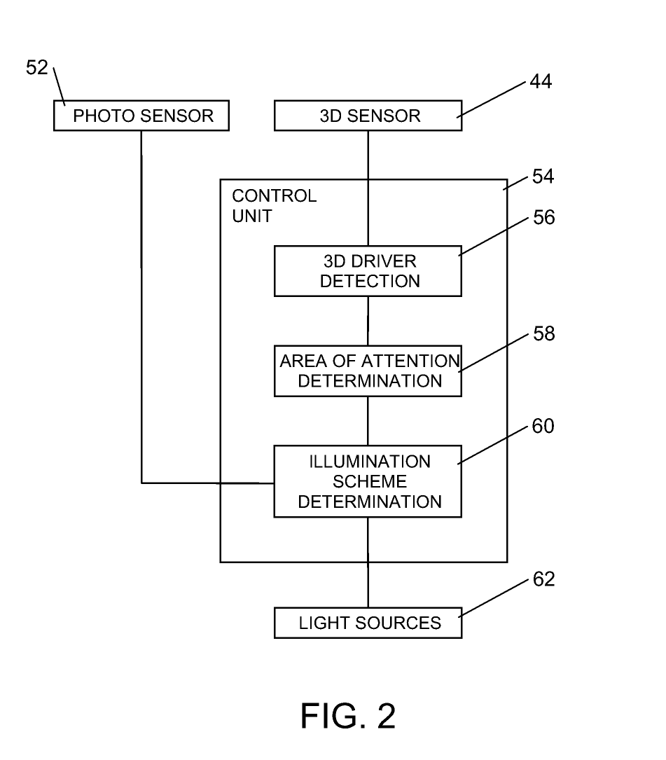

FIG. 2 is a block diagram illustrating in a simplified manner an exemplary embodiment of an illumination control according to the invention. The 3D sensor 44 is connected to a control unit 54. The 3D sensor 44 collects three-dimensional information about a driver 74 in the vehicle interior. The three-dimensional information is for example in the form of a video signal representing a depth map produced by a time-of flight 3D camera. The control unit 54 evaluates the three-dimensional information provided by the 3D sensor 44 and detects the driver 74 as an object in a three-dimensional space, as indicated by block 56. The control unit 54 uses a real-time vision calculation process in order to detect the head pose and head position. In accordance with another embodiment, the body position and body posture of the driver 74 are also detected. The head pose and head position allow the control unit 54 to determine whether the driver 74 is for example looking straight ahead, whether the driver 74 is looking at the instrument cluster 14 or whether the driver 74 is looking at the center stack 16 or at the center console 17. The control unit 54 thus determines an area of attention as indicated by block 58 in FIG. 2. Based on the area of the driver's attention and based on the ambient light level, which is measured by one or more photosensors 52, the control unit 54 selects an illumination scheme, as indicated by block 60 in FIG. 2. Light sources 62 in the vehicle interior 10 are controlled in accordance a given illumination scheme. The area of attention is ordinarily defined by an area the driver is looking at. The area of attention may however also be defined by the driver's body leaning towards or turning to an area of attention.

In accordance with an embodiment of the invention, the illumination scheme makes sure that the brightness of light sources 62 in the peripheral view region of the driver 74 is reduced. The control unit 54 may further use an illumination scheme that reduces an illumination for displays during night driving, if the driver 74 looks straight ahead onto the road. A display is understood as any visual presentation of information such as a navigation screen, a speedometer in the instrument cluster or illuminated controls on the center stack. Detecting the ambient light level with a photosensor integrated in the display allows a local adjustment of the back illumination for different regions of a display in order to increase the overall display contrast and thus a reduction of glare.

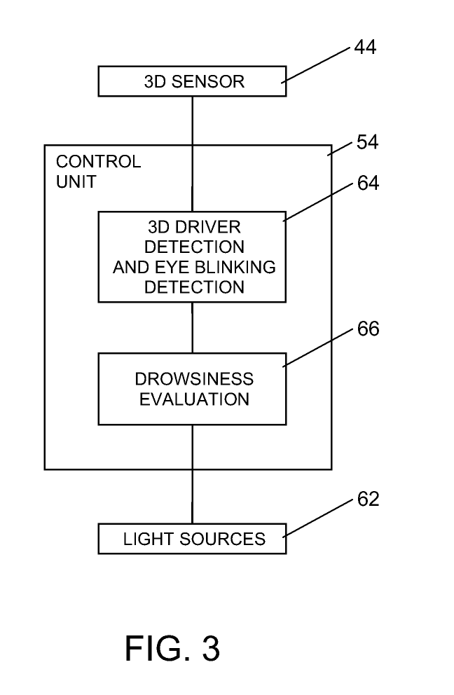

FIG. 3 is a block diagram illustrating in a simplified manner an exemplary embodiment of a drowsiness detection according to the invention. The 3D sensor 44 detects three-dimensional information about the driver 74. The three-dimensional information is then processed by the control unit 54 in order to determine a head pose, a head position, a body position and/or a body posture. Additionally, the eyes of the driver 74 may be monitored in order to detect eye blinking information, such as a duration of eye closure and an interval between blinking, as indicated by block 64.

Based on the pose, the position and/or the movement of the head or the body and based on the eye blinking information, it is determined whether the driver 74 is drowsy, as schematically indicated by block 66 in FIG. 3. If it is determined that the driver 74 is drowsy, the driver 74 is alerted by increasing ambient lighting with light sources 62 in the vehicle. Additional optical, acoustic or haptic alerts may be provided in order to alert the driver 74.

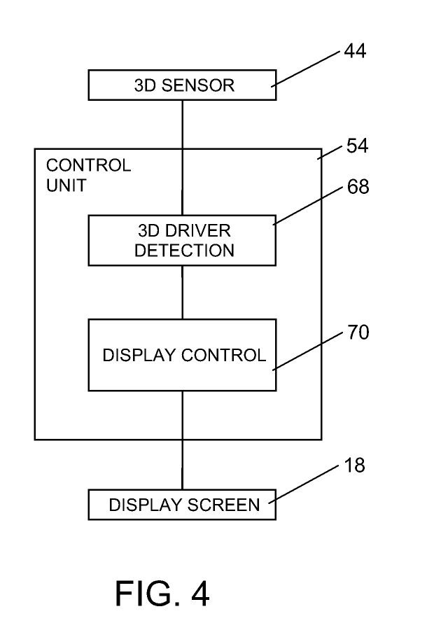

FIG. 4 is a block diagram illustrating in a simplified manner an exemplary embodiment of a display control according to the invention. In this case, a display control 70 operates to control the visibility of display screen information. A 3D sensor 44 is used to collect three-dimensional information about the driver 74 in order to determine a head pose and a head position in the vehicle interior as indicated by block 68. The visibility of information on the display screen 18 is improved by increasing a brightness of the display screen 18, if it is determined that the driver 74 looks at the display screen. The brightness of the display screen 18 is reduced again, if it is determined that the driver 74 does not look at the display screen 18 anymore. Reducing the brightness of the display screen 18 may include turning off the display screen 18 after the driver 74 looks straight ahead for a given amount of time. If the driver looks at the display screen 18 again, the brightness of the display screen 18 is increased again. The control of the brightness of the display screen 18 may be combined with the control of the illumination of buttons and dials on the center stack 16, on the center console 17 and the control of the ambient lighting in the vehicle in order to improve visibility conditions for the driver 74.

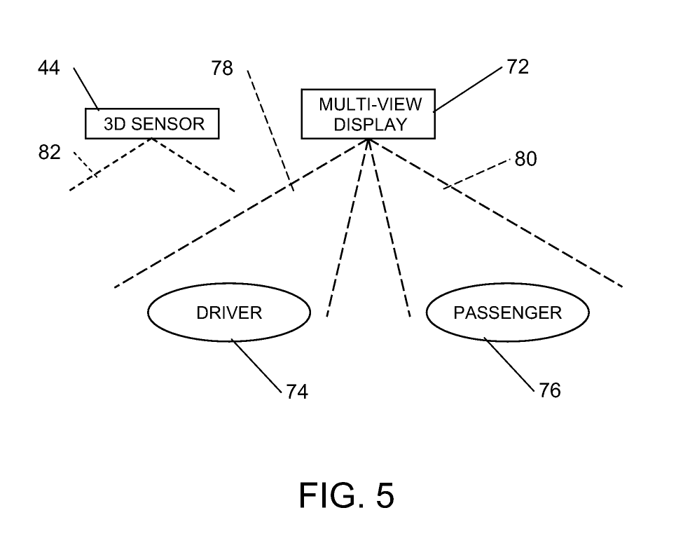

FIG. 5 is a schematic top view for illustrating display viewing angle ranges of a multi-view display 72 controlled in accordance with the invention. In accordance with an embodiment of the invention, a multi-view display 72 is mounted in the center stack 16 such that display screen information on the multi-view display 72 can be seen by the driver 74 and the passenger 76. The display screen information that is visible on the multi-view display 72 depends on the angle at which a viewer looks at the display screen. The driver 74, who is positioned within a first display viewing angle range 78, may for example see navigation information on the display screen whereas the passenger 76, who is positioned within a second display viewing angle range 80 may watch an entertainment video. The display screen is controlled such that the display screen information provided for the viewer in the second display viewing angle range 80 is turned off if the control unit 54 determines, based on information provided by the 3D sensor 44, that the driver 74 looks at the display screen information intended for the passenger 76. The scanning angle range 82 of the 3D sensor 44 is schematically indicated by dashed lines. This embodiment allows a passenger to see information that is not intended for the driver 74 and, at the same time, prevents the driver 74 from being distracted by that information.

Further advantages and features of the methods according to the invention are described in the following. As mentioned above, three-dimensional information about the driver's environment is detected by using a 3D sensor, which may either be a stereoscopic camera system, a time-of-flight 3D camera, a laser based system, such as a laser scanner, a capacitive proximity sensor, or any other system that can detect objects in a three-dimensional space. The data provided by the 3D sensor is then processed by using a head pose detection method in order to extract the driver's head position and orientation. The detected head pose of the driver 74, is used to determine the driver's focus of attention on a given coordinate system. Based on this information, a specific illumination scheme is determined such that the illumination is appropriate for the driver's condition and needs. By dynamically adjusting the interior lighting of the vehicle, it is possible to make the interior of the vehicle more pleasant during night driving. Safety is increased by reducing the distraction produced by bright displays in the driver's peripheral view. Driver fatigue created by harsh or unpleasant illumination is reduced. The effect of glare is reduced by combining head pose information with ambient light information from photosensors installed in the vehicle or integrated in the displays and by locally adjusting the back illumination of different sections of a display in dependence on this information in order to enhance an overall display contrast. Another advantage of using an illumination scheme that reduces glare and harsh lighting is that the perceived quality of the vehicle's interior is increased.

As explained above, a sufficiently accurate head or body pose estimation allows a direct control of information on vehicle displays. If a the display screen 18 is angled towards the front passenger 76 in order to allow the front passenger to view a movie, the control unit 54 may automatically turn the movie off if the driver 74 glances at the display screen 18 or leans over to look at the display screen 18. This feature reduces driver distraction and enhances safety while permitting the use of entertainment displays in the front-cabin of the vehicle. This feature is advantageous in cases when, by law, an entertainment video in the front-cabin of the vehicle is forbidden, if the driver 74 can see the entertainment video.

In accordance with another embodiment as mentioned above, the vehicle is equipped with a multi-view display 72 that shows different content at different viewing angles. The multi-view display 72 may for example show navigation for the driver 74 and an entertainment movie for the passenger 76. The entertainment content can be turned off, if the driver's viewing angle changes in such a way that it would make the movie visible to the driver 74. In accordance with a further feature of the invention, in case of a multi-view display where a display viewing angle range of a display image is adjustable, a head pose and head position detection may be configured such that the display viewing angle range or viewing cone for the driver 74 expands and contracts in dependence on the driver's head or body movements such that the display screen is adjusted to provide optimal viewing conditions.

In accordance with a preferred mode, the 3D sensor 44 is based on a time-of-flight camera. This type of sensors is commercially available from companies such as 3DV SYSTEMS LTD., CANESTA INC. and PMD TECHNOLOGIES GMBH. A time-of-flight 3D sensor 44 generally uses modulated infrared or near infrared light emitted by an array of diodes. The emitted light is used to calculate the time the light took to bounce off of the surface of a detected object, making it possible to calculate the distance between the sensor surface and three-dimensional features of an object in a three dimensional space. A real-time vision calculation procedure is used to estimate the head pose. This calculation procedure uses a video signal and matches the detected head position on the video with the head features in a 3D virtual world generated using 3D sensor data. In this manner, a high accuracy for the head pose estimation is achieved. An advantage of the calculation procedure is that it permits the head pose estimation system to be independent of the subject's identity and that the head pose estimation system works without an initial training.

The 3D sensor 44 can be mounted in any position inside of the vehicle that allows it to get an unobstructed view of the driver's head from the front. Preferred locations are, as mentioned above, the vehicle A-pillar 48, the rear view mirror 46 and the front portion of the vehicle roof liner 50. The above described exemplary embodiments allow adjusting the lighting intensity of the center display with the instrument cluster 14, the center stack 16 and the center console 17 based on the driver's head pose. However, the lighting adjustment is not limited to only the buttons, controls or displays in the vehicle, but also includes ambient lighting such as a dome light, reading lights or foot well ambient lighting. The lighting schemes may incorporate not only dimming but also changing colors or changing a lighting for providing visual contrasts between different parts of the vehicle cockpit.

Some of the above-described embodiments focus on adjusting vehicle lighting or display content to optimize comfort and to minimize distractions. This generally implies a reduction of ambient lighting or content with moving images. Other ones of the above-described embodiments involve actively combining the head pose detection with a method to detect a drowsy driver. In this case ambient lighting is preferably increased to wake up the driver. Certain head poses can be classified as being indicative of a drowsy driver and thus certain head poses may be used to trigger an increased lighting. The detection of drowsiness can be further improved if a head pose estimation and a detected eye blinking rate are combined.

What is claimed is:

1. A method for controlling an illumination in a vehicle interior, the method which comprises:
collecting, with a 3D sensor provided in a vehicle interior, three-dimensional information about a driver in the vehicle interior;
detecting the driver as an object in a three-dimensional space by processing the three-dimensional information about the driver;
determining at least one three-dimensional driver characteristic selected from the group consisting of a head pose, a head position, a body position and a body posture;
determining an area of attention of the driver by evaluating the at least one three-dimensional driver characteristic; and
determining an illumination scheme based on the area of attention of the driver such that vision conditions for the driver are improved.

2. The method according to claim 1, which comprises:
determining a peripheral view region of the driver based on the at least one three-dimensional driver characteristic; and
determining an illumination scheme having a reduced brightness for light sources in the peripheral view region of the driver.

3. The method according to claim 1, which comprises improving vision conditions during night driving by reducing an illumination for displays in the vehicle interior, if the step of determining an area of attention of the driver determines that the driver looks straight ahead.

4. The method according to claim 1, which comprises:
sensing an ambient light level by using a photosensor;
determining an illumination scheme based on the area of attention of the driver and based on the ambient light level such that a back illumination of a display is locally adjusted for different regions of the display in order to enhance an overall display contrast.

5. The method according to claim 1, which comprises using, as the 3D sensor, a sensor device selected from the group consisting of a time-of-flight 3D camera, a stereoscopic camera system, a laser scanner system and a capacitive proximity sensor.

6. The method according to claim 1, which comprises providing the 3D sensor on a vehicle component selected from the group consisting of a vehicle A-pillar, a vehicle roof liner and a vehicle rear view mirror.

7. The method according to claim 1, which comprises adjusting an illumination for a device selected from the group consisting of a display, a push button, a rotary dial, a rotary-push knob, a scroll wheel and an instrument cluster in accordance with the illumination scheme.

8. The method according to claim 1, which comprises adjusting at least one ambient lighting source selected from the group consisting of a dome light and a foot well lighting source in accordance with the illumination scheme.

9. The method according to claim 1, which comprises increasing an illumination level for a display located in the area of attention of the driver.

10. A method for detecting driver drowsiness, the method which comprises:
collecting, with a 3D sensor provided in a vehicle interior, three-dimensional information about a driver in the vehicle interior;
detecting the driver as an object in a three-dimensional space by processing the three-dimensional information about the driver;
determining at least one three-dimensional driver characteristic selected from the group consisting of a head pose, a head position, a body position and a body posture;
detecting a driver drowsiness based on an evaluation of the at least one three-dimensional driver characteristic; and
triggering a measure for alerting the driver, if a driver drowsiness is detected.

11. The method according to claim 10, which comprises:
detecting eye blinking information by monitoring an eye of the driver; and
detecting a driver drowsiness based on an evaluation of the at least one three-dimensional driver characteristic and based on the eye blinking information.

12. The method according to claim 10, which comprises increasing a lighting level in the vehicle interior for alerting the driver, if a driver drowsiness is detected.

13. A method for controlling a visibility of display screen information, the method which comprises:
collecting, with a 3D sensor provided in a vehicle interior, three-dimensional information about a driver in the vehicle interior;
detecting the driver as an object in a three-dimensional space by processing the three-dimensional information about the driver;
determining at least one three-dimensional driver characteristic selected from the group consisting of a head pose, a head position, a body position and a body posture;
evaluating the at least one three-dimensional driver characteristic; and
controlling a display screen such that a visibility of information on the display screen is adjusted in dependence on an evaluation of the at least one driver characteristic.

14. The method according to claim 13, wherein the step of controlling the display screen includes selectively increasing a brightness of the display screen, if an evaluation of the at least one three-dimensional driver characteristic determines that the driver looks at the display screen and reducing a brightness of the display screen, if an evaluation of the at least one three-dimensional driver characteristic determines that the driver does not look at the display screen.

15. The method according to claim 13, which comprises:
providing, with the display screen, a first display screen information for the driver, the first display screen information being viewable in a first display viewing angle range and providing, with the display screen, a second display screen information for a passenger, the second display screen information being viewable in a second display viewing angle range; and
controlling the display screen such that the second display screen information is turned off, if an evaluation of the at least one three-dimensional driver characteristic determines that the driver looks at the second display screen information.

16. The method according to claim 13, which comprises:
providing, with the display screen, a first display screen information for the driver, the first display screen information being viewable in a first display viewing angle range and providing, with the display screen, a second display screen information for a passenger, the second display screen information being viewable in a second display viewing angle range; and
controlling the display screen such that at least the first display viewing angle range selectively expands and contracts in dependence on an evaluation of the at least one three-dimensional driver characteristic.

17. The method according to claim 13, which comprises:
providing the display screen such that the display screen is angled toward a front passenger for presenting display screen information to the front passenger; and
controlling the display screen such that the display screen information is turned off, if an evaluation of the at least one three-dimensional driver characteristic determines that the driver looks at the display screen information.
